(19) United States
(12) Patent Application Publication
(10) Pub. No.: US 2022/0298800 A1
(43) Pub. Date: Sep. 22, 2022

(54) FABRIC WALLPAPER AND ITS MANUFACTURING METHOD

(71) Applicant: SEEWOO PARK, Seoul (KR)

(72) Inventor: SEEWOO PARK, Seoul (KR)

(21) Appl. No.: 17/836,753

(22) Filed: Jun. 9, 2022

Related U.S. Application Data
(62) Division of application No. 17/377,040, filed on Jul. 15, 2021.

(30) Foreign Application Priority Data
Jul. 23, 2020 (KR) 10-2020-0091371

(51) Int. Cl. E04F 13/00; D02G 3/36; C09J 7/38; C09J 7/40; C09J 7/21

(52) U.S. Cl. CPC E04F 13/002; D02G 3/36; C09J 7/38; C09J 7/405; C09J 7/21; C09J 2427/006; C09J 2400/263; C09J 2400/28; C09J 2467/006; Y10T 428/14; C09J 2301/16

(57) ABSTRACT

Proposed is a method of manufacturing a fabric wallpaper, while a bonding force of an adhesive agent attached to one side of fabric wallpaper is enhanced, and flame retarding is given to a wrap and a weft for weaving fabric at the same time. Accordingly, safety is guaranteed against the fire without additional anti-flaming treatment. Also when constructing the fabric wallpaper, general unskilled consumers may easily and conveniently perform construction. Fabric is woven by a warp and a weft of synthetic fibrous yarn in which a flame retardant resin layer is formed on the outer surface of the core. One side of the fabric is heated and pressed to form a smooth surface in which part of the resin layer is melted and extended. An adhesive agent is attached to the smooth surface, and release paper is attached to the outer surface of the adhesive agent.

### CROSS REFERENCES TO RELATED APPLICATION

This application is a divisional of U.S. application Ser. No. 17/377,040, filed on Jul. 15, 2021, which claims priority to KR10-2020-0091371, filed on Jul. 23, 2020, the entire disclosure of which is incorporated herein by reference.

### BACKGROUND OF THE INVENTION

### Field of the Invention

The present disclosure relates to a fabric wallpaper and its manufacturing method. An adhesive adheres to one side of the fabric wallpaper by a release paper, and accordingly, when constructing the fabric wallpaper, any person may easily work after separating the release paper. In particular, the adhesive strength between the adhesive and fabric wallpaper increases, the fabric wallpaper separation or a partial lift of a bonding surface may be prevented, after the construction. Also, a warp and a weft for weaving a fabric are coated with a flame retardant resin, so that safety is guaranteed against the fire.

### Background of the Related Art

In general, a wallpaper is a generic term of a kind of sheet which adheres to a wall surface for the purpose of interior decoration. Although paper material is mainly used, various materials such as vinyl, fabric, and wood have been recently developed, so that a range of choices is widening according to a purpose, a function, and a sense of aesthetic.

In addition, according to the improvement of a standard of living, a variety of forms of wallpaper is demanded, and recently the fabric wallpaper is gaining interests.

However, there is a difficulty of work in a method of attaching fabric wallpaper to the wall surface. As a method for solving the problem above-mentioned, a method of attaching to a rear surface of the fabric for adhering has been provided.

As one means of a method for attaching fabric, a laminating method has been provided. However, the method may be limitedly applied only to some types of the fabric due to a difference in the physical property between fabric and adhesive paper. There is much difficulty in providing various types of fabric wallpaper.

Referring to the conventional art of the fabric wallpaper, Korean patent publication No. 10-0867187, functional fiber wallpaper and its manufacturing method (Patent literature 1), Korean patent publication No. 10-0925708, wall-paper of fabric and the method of adhesion of fabric and paper (Patent literature 2), and Korean patent publication No. 10-1139257, a method for manufacturing a fabric wall and a fabric wall thereof (Patent literature 3) have been provided.

Technical content of patent literature 1 featured a method of manufacturing fiber wallpaper by using fiber fabric treated with anti-flaming processing, the method comprising in the steps of: transferring and printing a printing pattern by using watercolor ink on one side of fiber fabric; coating the other side of the fiber fabric with coating liquid made by mixing in a ratio of 54 wt % of a functional resin, 28 wt % of an organic solvent, and 18 wt % of a flame retardant; applying adhesive liquid made by mixing in a ratio of 50 wt % of a functional resin, 25 wt % of an organic solvent, 5 wt % of a cross-linking agent, and 20 wt % of a flame retardant to a coating surface formed by the coating; and attaching release paper to an adhesive surface formed by applying the adhesive liquid.

Technical content of patent literature 2 featured a laminating method in a process of manufacturing adhesive wallpaper, the method comprising in the steps of: in a working process of attaching the fabric and adhesive paper, a crease generation phenomenon and a bubble generation phenomenon which are problems of fabric adhesive wallpaper may be prevented by using a tension control device of a fabric sending part. Accordingly, adhesion of many kinds of fabric in which density and thickness of fabric are different is possible. A new image may be expressed by inserting images to adhesive paper and attaching the same to a thin fabric. In part of the fabric, fabric that is woven without a selvage of fabric or fabric in which a selvage is removed is used. Accordingly, a U-shape phenomenon which is another problem of fabric adhesive paper is removed. Concurrently, a fabric having a wider width than that of adhesive paper is attached, thereby making papering work easy.

In patent literature 3, a hot melt film is inserted between fiber and a member to be bonded by thermal melting. Accordingly, elasticity in a direction of a length and a width coming from a warp and a weft upon weaving of fiber is fixated by a physical force provided by the member, and a function of suppressing expression to the fiber is given thanks to a hot melt blocking layer. Accordingly, in spite of applying an aqueous or oil-based adhesive agent or adhesive in an emulsion state, there is no change in fiber color, wherein release paper is attached to an outer surface of the adhesive.

As described in patent literatures 1 to 3, various types of fabric wallpaper have been provided. However, in the case of patent literatures 1 and 3, a means for forming an additional coating layer on a surface of fabric or adding a hot melt and a member is needed in order to increase adhesiveness between fabric and the adhesive. Therefore, there is a disadvantage that a configuration becomes complex.

Also, the case of patent literature 2 has a structure that an adhesive applied to adhesive paper is attached to one side of the fabric. Therefore, there is a disadvantage that adhesiveness between the adhesive and fabric is insufficient. In the case of the above patent literatures, there is a disadvantage that additional anti-flaming processing is needed.

### PATENT LITERATURES

(Patent literature 1) Korean patent publication No. 10-0867187, functional fiber wallpaper and its manufacturing method
(Patent literature 2) Korean patent publication No. 10-0925708, wall-paper of fabric and the method of adhesion of fabric and paper
(Patent literature 3) Korean patent publication No. 10-1139257, a method for manufacturing a fabric wall and a fabric wall thereof

### SUMMARY OF THE INVENTION

The present disclosure relates to manufacturing a fabric wallpaper, while a bonding force of an adhesive agent attached to one side of the fabric wallpaper is enhanced, and flame retarding is given to a wrap and a weft for weaving a fabric at the same time. Accordingly, safety is guaranteed against the fire without additional anti-flaming treatment. Also when constructing the fabric wallpaper, general unskilled consumers may easily and conveniently perform construction.

As a means of the present disclosure for solving the above problems, the fabric wallpaper is manufactured by the following. A synthetic resin to which a flame retardant is added is applied on an outer surface of a core made of synthetic fibrous yarn, thereby forming a resin layer. Fabric is woven by a warp and a weft of synthetic fibrous yarn in which a flame retardant resin layer is formed on the outer surface of the core. One side of the fabric is heated and pressed to form a smooth surface in which part of the resin layer is melted and extended. An adhesive agent is attached to the smooth surface, and release paper is attached to the outer surface of the adhesive agent.

### BRIEF DESCRIPTION OF THE DRAWINGS

FIG. 1 is a view of a device for manufacturing processed fabric in which a smooth, flat surface is formed by heating and pressing a reverse side of fabric according to the present disclosure.

FIG. 2 is a view of a device for manufacturing a fabric wallpaper by attaching an adhesive agent and release paper on a reverse surface of processed fabric manufactured in FIG. 1.

FIG. 3 is a view of a configuration of a synthetic fibrous yarn used as a warp and a weft upon weaving the fabric of the present disclosure.

FIG. 4 is a view of a configuration of a fabric tissue woven by the synthetic fibrous yarn of FIG. 3.

FIG. 5 is a view of a configuration of the processed fabric manufactured by heating and pressing a reverse side of fabric of FIG. 4.

FIG. 6 is a view of a state that an adhesive agent and release paper are attached to the processed fabric of FIG. 5.

FIG. 7 is a view of a state that the release paper is detached in a state of FIG. 6.

### DETAILED DESCRIPTION OF THE PREFERRED EMBODIMENT

Hereinafter, embodiments of the present disclosure are specifically described according to the attached drawings.

The present disclosure relates to a fabric wallpaper 10 in which an adhesive agent 21 and release paper 22 are attached to one side of fabric 20. Particularly, a flame retardant function is given to the fabric wallpaper 10, and strong bonding between the fabric 20 and the adhesive agent 21 may be made at the same time.

To give the flame retardant function to the fabric wallpaper 10 is generally performed.

According to the present disclosure, flame retarding is given to synthetic fibrous yarn 30 used as a warp and a weft upon weaving the fabric 20.

That is, the synthetic fibrous yarn 30 is obtained by coating an outer surface of the core 31 with a resin layer 32 to which a flame retardant and a plasticizer are added, and the fabric 20 is woven by a warp and a weft of the synthetic fibrous yarn 30. Accordingly, flame retarding is given without performing additional anti-flaming processing.

The core 31 used in the above uses thick polyester yarn of from 100 to 1000 d(denier), and a resin layer 32 may use any one resin of PVC, TPU, EVA, PP, PE, and PET. PVC is used in an embodiment of the present disclosure.

As a means for strong bonding between the fabric 20 and the adhesive agent 21, one side of the fabric 20 is heated and pressed, and part of the resin layer 32 coated on an outer surface of the core 31 is hot-pressed and melted to form a smooth surface 33. Accordingly, a bonding force with the adhesive agent 21 may be increased.

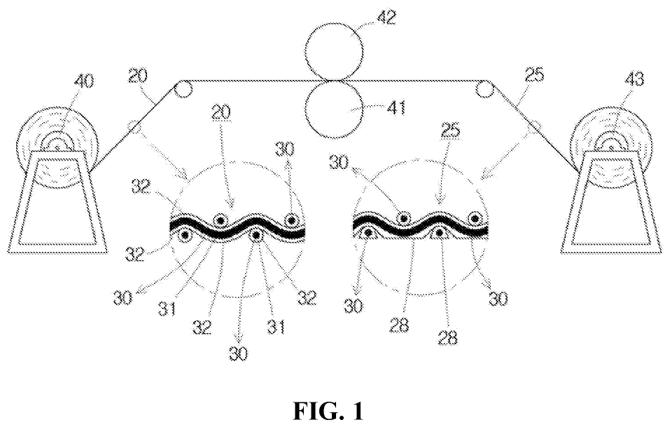

FIG. 1 is directed to a device of heating and pressing a reverse side 26 of the fabric 20 to form a smooth, flat surface 28 on the reverse side 26 of the fabric 20. A principle of the device is the same as that of the so-called cire finish.

That is, the fabric 20 is woven by the warp and the weft of a synthetic fibrous yarn 30 in which an outer surface of the core 31 is coated with the flame retardant resin layer 32. The fabric 20 is sent from a fabric sending roller 40 winding the fabric 20 to be passed through between a heating roller 41 and a pressurized roller 42. Accordingly, a smooth, flat surface 28 is formed on the reverse surface 26 of the fabric 20 as shown in FIG. 5.

Here, a heating temperature of the heating roller 41 positioned at a lower portion is made for heating at a temperature between a glass transition temperature and a melting point of the resin layer 32 made of PVC. The pressurized roller 42 positioned at an upper portion is made to be maintained at room temperature.

Therefore, if the fabric 20 in a state such as FIG. 4 is passed through between the pressurized roller 42 and the heating roller 41, part of the resin layer 32 positioned at the outer surface of the core 31 is melted, so that the smooth, flat surface 28 is formed on the reverse side 26 of the fabric 20 such as FIG. 5. However, a surface 27 may be maintained in an original form of a fabric tissue without deformation of the form thanks to the pressurized roller 42 maintained at room temperature.

As being passed through the pressurized roller 42 and the heating roller 41, the processed fabric 25 in which the smooth surface 28 is formed on the reverse side 26 of the fabric 20 is sequentially wound by a winding roller 43 for processed fabric positioned at a rear side.

The processed fabric 25 wound by the winding roller 43 for processed fabric goes through a step of manufacturing fabric wallpaper 10 by attaching the adhesive agent 21 and the release paper 22 via laminating processing, to the reverse side 26 of the processed fabric 25 in which the smooth, flat surface 28 is formed by the cire finish.

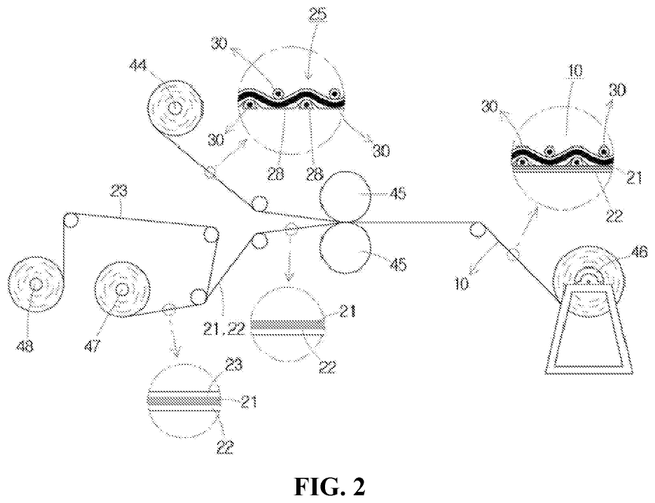

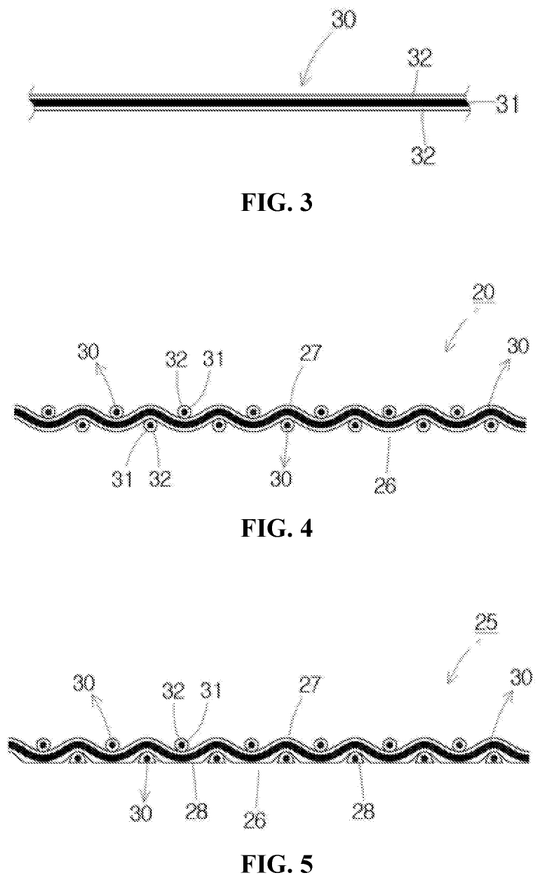

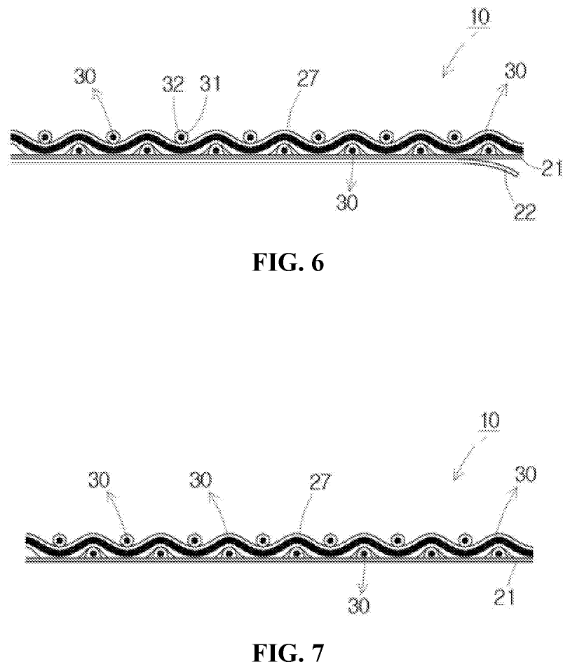

That is, as shown in FIG. 2, the processed fabric 25 in which the smooth surface 28 is formed on the reverse side 26 is positioned at a sending roller for processed fabric 44, is passed through a pair of pressure rollers 45, and is wound by a winding roller for fabric wallpaper 46.

Here, a sending roller for release paper 47 winding the release paper 22 to which the adhesive agent 21 is applied is installed below the sending roller for processed fabric 44. The release paper 22 is sent together with the adhesive agent 21 wound by the sending roller for release paper 47. Accordingly, the adhesive agent 21 applied to the release paper 22 is supplied between a pair of pressure rollers 45 to be in contact with the reverse side 26 of the processed fabric 25, i.e., the smooth surface 28. Then, the above is pressurized by the pressure roller 45, so that the adhesive agent 21 and the release paper 22 are in contact with the reverse side 26 of the pressed fabric 25. Accordingly, fabric wallpaper 10 is manufactured. The fabric wallpaper 10 is wound by the winding roller for fabric wallpaper 46.

In the above, on the reverse side 26 of the pressed fabric 25 to which the adhesive agent 21 is attached, the smooth surface 28 in which part of the flame retardant resin layer 32 coatings the synthetic fibrous yarn 30 used as the warp and weft, i.e., the outer surface of the core 31 is hot-pressed via the cire finish is formed. Accordingly, a bonding area with the adhesive agent 21 is made to be wide. Therefore, a bonding force between the processed fabric 25 and the adhesive agent 21 is strongly formed.

In the above, additional separate paper 23 is attached to one side of the adhesive agent 21 sent from the sending roller for release paper 47, is separated from the adhesive agent 21 before attaching the adhesive agent 21 and the processed wallpaper 25, and is wound by an additional winding roller for separate paper 48. Accordingly, smooth boding work may be made.

As described above, the fabric wallpaper 10 of the present disclosure has no need for additional flame retarding processing or anti-flaming processing after weaving the fabric 20. This is because upon weaving the fabric 20 for manufacturing the fabric wallpaper 10, the synthetic fibrous yarn 30 used as the warp and the weft, the outer surface of the most thick core 31 of 100 to 1000 d(denier), is coated with the resin layer 32 to which the flame retardant and the plasticizer are added.

Also, the manufactured fabric 20 has a configuration that the reverse side 26 of the fabric 20 is heated and pressed by the heating roller 41 via cire finish, part of the resin layer 32 coating the outer surface of the core 31 is thermally transformed to form the smooth surface 28, and thus the smooth surface 28 and the adhesive agent 21 are attached. Due to the above, a strong bonding force between the processed fabric 25 and the adhesive agent 21 may be expected. Accordingly, a phenomenon that upon constructing the fabric wallpaper 10, fabric wallpaper 10 is separated or lifted from a wall surface may be prevented.

If the fabric wallpaper 10 needs to be constructed at the desired position, the above may be cut in a desired size and shape. Then, the release paper 22 attached to one side of the adhesive agent 21 is separated, and then the above may be conveniently attached. Therefore, any person easily performs construction of the fabric wallpaper 10.

According to the present disclosure, fabric wallpaper is manufactured by forming a resin layer by applying a synthetic resin to which a flame retardant is added on an outer surface of a core made of synthetic fibrous yarn, weaving fabric by a warp and a weft of the synthetic fibrous yarn in which a flame retardant resin layer is formed on the outer surface of the core, forming a smooth surface in which part of the resin layer is melted and extended by heating and pressing one side of the fabric, attaching an adhesive agent to the smooth surface, and attaching release paper to an outer surface of the adhesive agent. Accordingly, a bonding force of an adhesive agent is enhanced, and flame retarding is given to the wrap and the weft for weaving fabric at the same time. Therefore, there are effects such that safety is guaranteed against the fire without additional anti-flaming treatment, and also when constructing fabric wallpaper, general unskilled consumers may easily and conveniently perform construction.

### DESCRIPTION OF SYMBOLS

10: Fabric wallpaper
20: Fabric
21: Adhesive agent
22: Release paper
23: Separate paper
25: Processed fabric
26: Reverse side
27: Surface
28: Smooth surface
30: Synthetic fibrous yarn
31: Core
32: Resin layer
40: Fabric sending roller
41: Heating roller
42: Pressurized roller
43: Winding roller for processed fabric
44: Sending roller for processed fabric
45: Pressure roller
46: Winding roller for fabric wallpaper
47: Sending roller for release paper
48: Winding roller for separate paper

What is claimed is:

1. A manufacturing method of a fabric wallpaper, the method comprising:
obtaining a synthetic fibrous yarn in which an outer surface of a core is coated with a flame retardant resin layer;
obtaining a fabric by a warp and a weft of the synthetic fibrous yarn;
obtaining a processed fabric, wherein the fabric is passed through between a pressurized roller and a heating roller, and the resin layer of the synthetic fibrous yarn positioned on a reverse side of the fabric is partially melted by the heating roller to form a flat surface; and
obtaining the fabric wallpaper, wherein the processed fabric and a release paper to which an adhesive agent is applied are passed through between a pair of pressurized rollers to attach the flat surface of the processed fabric and the adhesive agent applied to the release paper to each other, such that as being passed through the pair of pressurized rollers, the processed fabric, the adhesive agent, and the release paper are attached.
